(19) United States
(12) Patent Application Publication
(10) Pub. No.: US 2023/0008608 A1
(43) Pub. Date: Jan. 12, 2023

(54) RADIANT CEILING PANEL AND METHOD OF MANUFACTURING THE SAME

(71) Applicant: Schmöle GmbH, Fröndenberg (DE)

(72) Inventors: Marko TEMENT, Düsseldorf (DE); Andreas HARDER, Iserlohn (DE); Kristina BITTER MEIJK, Attendorn (DE)

(21) Appl. No.: 17/859,173

(22) Filed: Jul. 7, 2022

(30) Foreign Application Priority Data
Jul. 7, 2021 (DE) 10 2021 117 536.4

(51) Int. Cl. F24D 3/16; E04B 9/04; E04B 9/18; E04B 9/34; F24F 5/00

(52) U.S. Cl. CPC F24D 3/165; E04B 9/0435; E04B 9/18; E04B 9/34; F24F 5/0092

(57) ABSTRACT

A radiant ceiling panel for air conditioning of a room, including a radiating surface on which a tube system for conducting a fluid, in particular water, along the radiating surface is fixed, preferably directly. The length of the radiating surface exceeds its width by a multiple. The tube system includes at least two portions fluidically connected in parallel, in particular arranged in parallel. The radiant ceiling panel has a fastening system, in particular a rope-like fastening system, for freely suspended fastening to a ceiling, or at least elements for interacting with said fastening system. The at least two portions are guided together and back apart again in an assembly region of the radiating surface.

According to a first aspect, the present invention relates to a radiant ceiling panel for air conditioning of a room.

Such radiant ceiling panels, which are characterized by the fact that they are usually much longer than they are wide and are suspended from the ceiling, for example of a hall, by means of a rope-like fastening system, are known in principle from unverifiable printed prior art documents.

Typically, these radiant ceiling panels have corrugated radiating surfaces as part of holding cassettes, wherein straight tubular bodies are inserted into the corrugations.

Both the holding cassette with the radiating surface and the tubular bodies usually consist of carbon steel and are therefore relatively heavy, which in particular increases the installation costs, transportation costs, etc.

Also, because of this great weight, but in particular also because of the relatively large length of the whole radiant ceiling panel, the straight tube systems held by the cassette are typically formed from several pieces, each of which must be connected individually during assembly.

The individual, straight tube strands of the tube system are connected here in parallel in terms of flow and are typically guided together at the end and at the beginning of the entire radiant ceiling panel.

Proceeding from the aforementioned prior art, it is the object of the present invention to provide a radiant ceiling panel which is fundamentally easier to install and, if necessary, has a more elegant appearance.

The invention achieves the stated object in accordance with a first aspect by the features of claim 1, therefore in particular by the fact that the at least two portions of the tube system, which are fluidically connected in parallel, are guided together and back apart again in an assembly region of the radiating surface.

In other words, the concept of the invention lies in reducing the number of coupling points for simplified assembly of the tube system.

Specifically, this concept makes it possible to fit together a radiant ceiling panel from a plurality of pieces, wherein each of these pieces comprises a part of the tube system, without the need to connect each one of multiple straight tubes to a successor tube.

Rather, at least two of these tubes are combined beforehand so that only a single connection needs to be made for two or more portions of the tube system arranged in parallel and/or connected in parallel (rather than each tube portion needing to be coupled/connected individually).

Said assembly region of the radiating surface is a region around the radiating surface, in particular a region in which a plurality of pieces of the radiating surface are fitted together.

Typically, the radiating surface is not delivered to the installation site as a one-piece radiating surface, that is to say the radiant ceiling panel is not delivered in one piece. Rather, a plurality of pieces of the radiant ceiling panel are usually provided, each comprising one piece of the radiating surface and one piece of the tube system arranged thereon.

For assembly, the pieces of the tube system can then be assembled as the different radiant ceiling panel pieces are brought towards each other, and a part of the assembly region or the entire assembly region can then preferably be provided with a screen panel which likewise provides a part of the radiating surface.

In particular, the assembly region does not refer exclusively to the region of said screen panel. Rather, the assembly region can be somewhat broader or larger. Consequently, the at least two portions of the tube system do not have to be guided together and/or apart in the region of the screen panel. This can also be done at a distance, in the region of another radiating surface piece or radiant ceiling plate piece, which is thus included by the general assembly region.

Crucially, guiding the at least two portions together and back apart again simplifies the assembly of the entire radiant ceiling panel by minimizing the number of coupling points of the tube system.

In particular, of course, more than two portions, for example three or four or even more portions, can be guided together and back apart again.

It is, however, consequently also possible to provide several tuples (that is to say, for example, pairs) of at least two portions on the radiating surface, which are in each case guided together and apart again in the assembly region.

Even though the latter case provides for more than one coupling point for the tube system for the assembly of a radiant ceiling panel in the assembly region, the total number of coupling points can be minimized in this way.

A radiant ceiling panel typically comprises, on the whole, a radiating surface and a tube system arranged thereon. In accordance with the invention, the tube system has at least two portions here fluidically connected in parallel. This means that the medium or fluid (in particular water) does not pass through these two portions one after the other (as in the case of a tube meander, for example), but substantially alternatively or simultaneously. Consequently, part of the fluid flows or is directed along a bifurcation along the first portion and another part of the fluid along the other portion.

According to a preferred embodiment, the tube system is secured here directly to (or on the upper side of) the radiating surface. For this purpose, for example, heat conducting elements such as heat conducting plates can be provided. These can overlap parts of the tube system, for example.

Alternatively, the tube system can be welded or similar directly to the radiating surface.

“Directly” in the sense of the invention means that the tube system is not first assembled on an intermediate plate, which is then assembled on or adhesively bonded to the radiating surface, but that preferably no further intermediate elements are actually provided here.

Alternatively, the tube system can also rest on a heat conducting element, at least in portions, and thus indirectly on the radiating surface.

In contrast to the prior art mentioned at the outset, a very large reduction in weight can be made possible in accordance with the invention, since the tube system is made in particular of copper, aluminum or stainless steel.

The radiating surface can be provided in particular by a cassette.

In this sense, the radiating surface or the cassette can consist of aluminum in particular.

According to the most preferred embodiment of the invention, the tube system is arranged on a flat radiating surface or on a planar radiating surface. In contrast to the prior art, in which the radiating surface provides corrugations into which the tube system is inserted, the preferred arrangement on a planar radiating surface has the advantage of much better heat transfer and a more variable arrangement.

The efficiency of the entire radiant ceiling panel can be further increased by the tube system (or at least some regions or portions) having a D-shaped configuration in cross-section, wherein the flat side can then rest on the planar radiating surface to further improve the heat conduction.

The radiant ceiling panel is intended for air conditioning of a room. In particular, the room can be heated. Alternatively, however, a radiant ceiling panel can also be used in cases where the room is to be cooled (in the manner of an air conditioner). Depending on the design, either cooled or heated fluid is then conducted in the tube system.

Radiant ceiling panels are typically suspended from the ceiling of a room (for example, a hall). In contrast to other types of surface heat exchangers, they are not installed in the ceiling or plastered over or clad there. Therefore, there are typically no other elements arranged (such as plasterboard or the like) on their underside.

Rather, the underside of a radiant ceiling panel is typically directly visible to an observer located in the room (in this context, it should be noted that a corrugation-free radiating surface has appearance-related advantages here).

Such a room is typically delimited by the ceiling, a floor region, and at least one wall. However, some or all of these walls may also be omitted as appropriate. The room is thus defined in particular by the ceiling region and the floor region of the room.

For fastening to this ceiling there is provided a fastening system in the manner of a freely suspended fastening.

In this context, “freely suspended” is understood to mean a system that allows the radiant ceiling panel to be fastened to the ceiling without being placed on supports or rails or the like. Rather, the term “freely suspended” is intended to make it clear that the radiant ceiling panel is secured to the ceiling at the top by means arranged above the panel, for example by ropes/cables, rods, threaded rods or the like (in particular rod-shaped bodies).

The fastening system can optionally have mounting rails, in particular on the ceiling side. One or more radiant ceiling panels can then simply be hung from the mounting rails and are thus already oriented in particular.

The radiant ceiling panel can either comprise such a fastening system (for example, the radiant ceiling panel can be distributed together with ropes or the like). Alternatively, the radiant ceiling panel may merely include means for interacting with such a system. In this case, for example, receptacles, grooves, holes, eyelets, (transverse) webs, holes or the like may be provided on the radiant ceiling panel and may interact with means of a corresponding fastening system (for example, may be engaged from behind or engaged through by the latter).

Here, it should also be noted that the at least two portions of the tube system fluidically connected in parallel can in particular also be arranged in parallel, which allows a particularly space-saving arrangement on the radiating surface.

In accordance with a particularly advantageous embodiment of the invention, the at least two portions are guided together and apart again on or above the radiating surface. That is to say in particular that the region in which the two portions are guided together is typically also located on/above the radiating surface (and not, for example, in a gap). This also includes the case where the region in which the two portions are guided together is covered by a screen panel which provides part of the radiating surface.

Alternatively, however, it could also be provided that the region in which the two portions are guided together remains uncovered by a screen panel or the like.

According to a further advantageous embodiment of the invention, the tube system has a planar underside. As already indicated above, this allows a preferred, clearer appearance and is provided in particular for the case where the radiating surface is corrugation-free.

According to the most preferred embodiment of the invention, the radiating surface is provided by a cassette.

This means that the radiant ceiling panel as a whole comprises a cassette consisting of a radiating surface and (lateral) delimiting elements, which can in particular protrude at right angles from the radiating surface.

Typically, the radiating surface and the lateral delimiting elements are formed as one piece in an integrally-bonded manner.

Preferably, the cassette can consist of aluminum.

In the case of a cassette, the lateral delimiting elements initially allow the radiant ceiling panel to have a shell-like configuration, so that, for example, condensation or dust or the like located above the radiating surface cannot simply fall or flow down sideways from the radiant ceiling panel.

Such a configuration also allows, for example, the mounting of insulating materials in the radiant ceiling panel (above the tube system), which can serve to improve the acoustics and/or the thermal conductivity of the radiant ceiling panel.

Lastly, the delimiting elements also ensure a certain stability of the radiant ceiling panel as a whole or of the one radiant ceiling panel piece or cassette piece. In particular, they counteract any twisting of the radiant ceiling panel.

Furthermore, it should be noted that the radiating surface preferably consists of a plurality of pieces, specifically in particular in the longitudinal direction of the radiant ceiling panel.

Thus, the longitudinal direction is the direction of greatest extent of the radiant ceiling panel.

Typically, the cassette also consists of a plurality of parts, which are (must be) fitted together to assemble the radiant ceiling panel.

If the radiant ceiling panel consists of a plurality of pieces, it may thus be particularly advantageous provided that the radiating surface in the assembly region has a shorter piece, which is arranged between two longer pieces.

This piece may be referred to in particular as a screen panel. This can preferably form a piece of a cassette, given the case that the radiating surface is provided fundamentally by a cassette.

The shorter piece is typically attached here to the radiant ceiling panel during the installation process, after the corresponding tube system coupling points/tube system pieces have been connected in the assembly region.

In particular, special assembly means can be assigned to the shorter piece of the radiating surface and allow this piece to be assembled on the longer pieces with some clearance. Variable assembly means can thus be provided.

According to a further advantageous embodiment of the invention, the radiant ceiling panel has, in addition to the aforementioned at least two portions of the tube system, at least two further portions (in particular likewise arranged in parallel) which are likewise fluidically connected in parallel with one another and which are likewise guided together and back apart again in the assembly region, wherein these two portions are then connected in parallel as a whole to the first-mentioned at least two portions.

In particular, this means that at least two coupling points of the tube system are formed in the assembly region: one for each of said at least two portions.

Here, it should be noted that the tube system, in respect of its portions, can be completely guided together at the beginning or at the end of the radiant ceiling panel (in particular as considered in the longitudinal direction), so that, at each end of the radiant ceiling panel, there is typically a connection for the fluid to be conducted.

In accordance with a further advantageous embodiment of the invention, the tube system is fixed, at least in portions, to the radiating surface with the aid of heat conducting elements. Preferably, so-called heat-conducting plates can be used for this purpose, which in particular overlap straight portions of the tube system and are fixed with their wings to the radiating surface (for example are glued there or welded or similar). Alternatively, however, the tube system can also be fastened, for example directly welded, to the radiating surface without heat conducting elements.

In accordance with a further aspect of the invention, it achieves the object with a method for producing a radiant ceiling panel according to claim 10. In particular, this method comprises first securing at least two portions, fluidically connected in parallel, on a first piece of a radiating surface. These portions converge. The convergence may, but does not have to, occur on the first piece of the radiating surface.

The same applies to a second piece of the radiating surface, on which two portions (again) converge.

In accordance with the method, to complete or develop the radiant ceiling panel, the two pieces are guided towards one another in one direction, and then the coupling point of the tube system is connected first.

Preferably, the assembly region can then be covered or screened with a third, in particular shorter, piece of the radiating surface, for example a screen panel.

In this respect, it should be noted that all features and advantages which have been described above or will be described below with respect to the radiant ceiling panel according to the invention are of course also transferable to the method according to the invention and vice versa. These features and advantages are not explicitly repeated here, merely for reasons of clarity of the application.

Further advantages of the present invention will become clear from any dependent claims not cited and from the following description of the figures, in which:

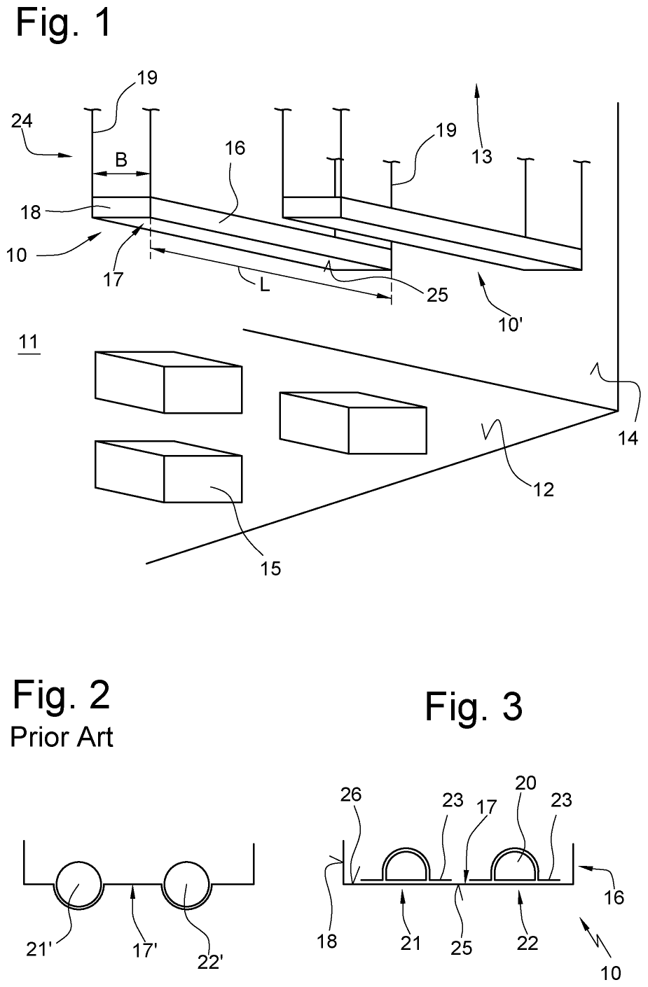

FIG. 1 in a very schematic, isometric partially cutaway oblique view, shows an exemplary room with two radiant ceiling panels according to the invention suspended side by side from an indicated ceiling,

FIG. 2 shows a section through a prior art radiant ceiling panel,

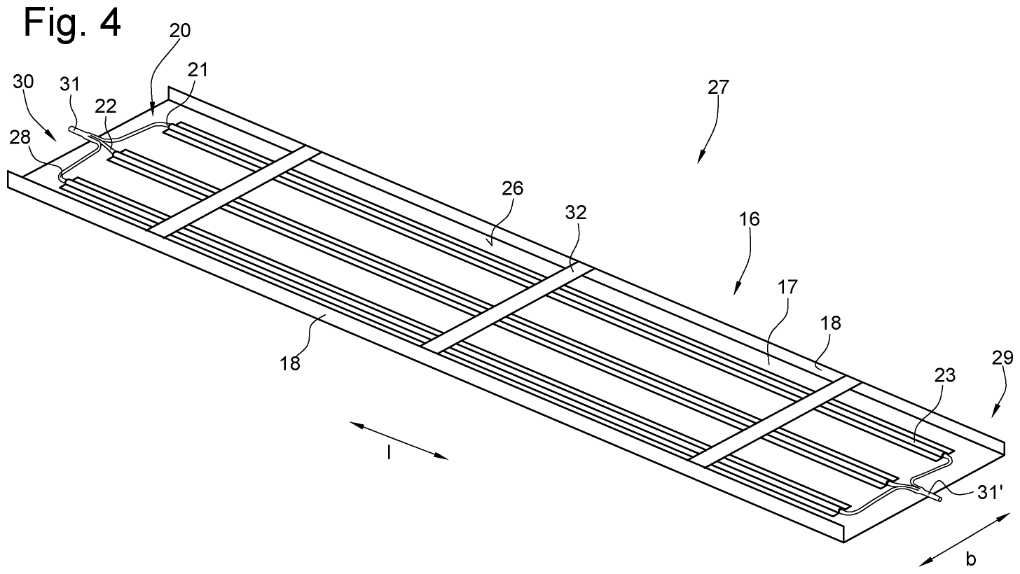

FIG. 3 in a view according to FIG. 2, i.e. approximately in a sectional plane orthogonal to the longitudinal extent L in FIG. 1, shows a section through a radiant ceiling panel according to the invention,

FIG. 4 a first piece of a radiant ceiling panel according to the invention in a very schematic oblique view,

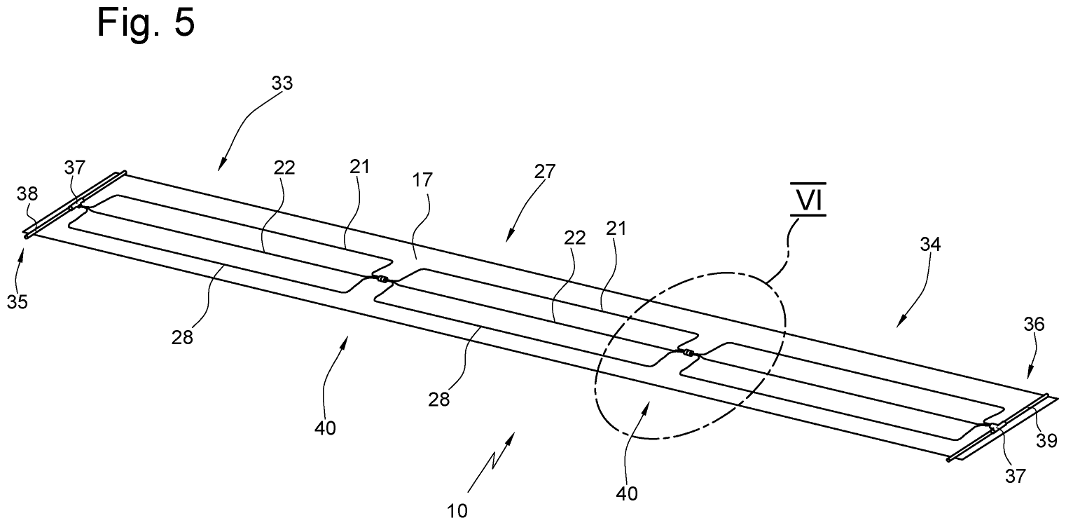

FIG. 5 in an even more schematic illustration, approximately in a view according to FIG. 4, but shown in a reduced size, shows a radiant ceiling panel completed from a plurality of pieces, but omitting some elements such as lateral delimitations of the cassette,

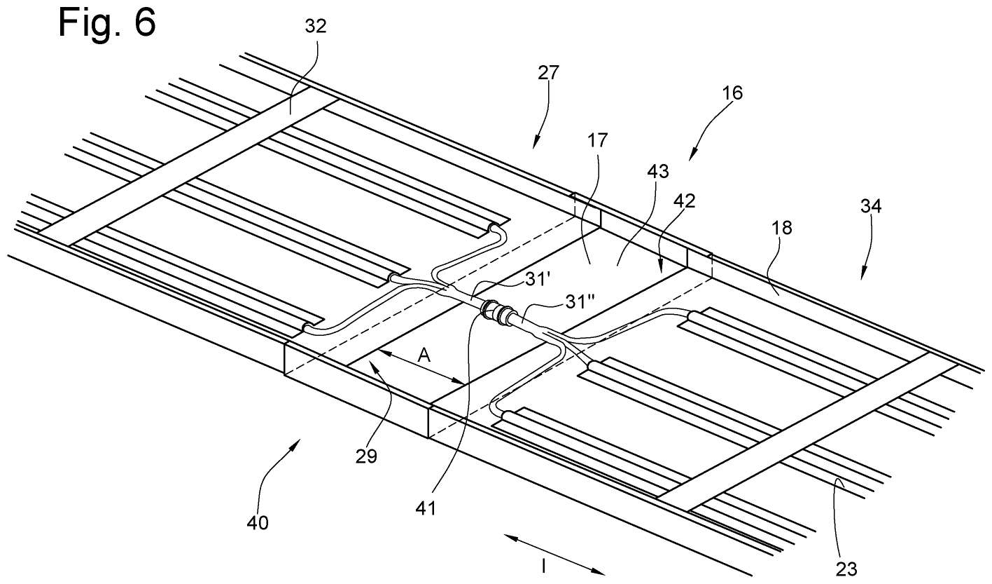

FIG. 6 in a slightly enlarged but schematic oblique top view, shows the region denoted by reference character VI in FIG. 5, and

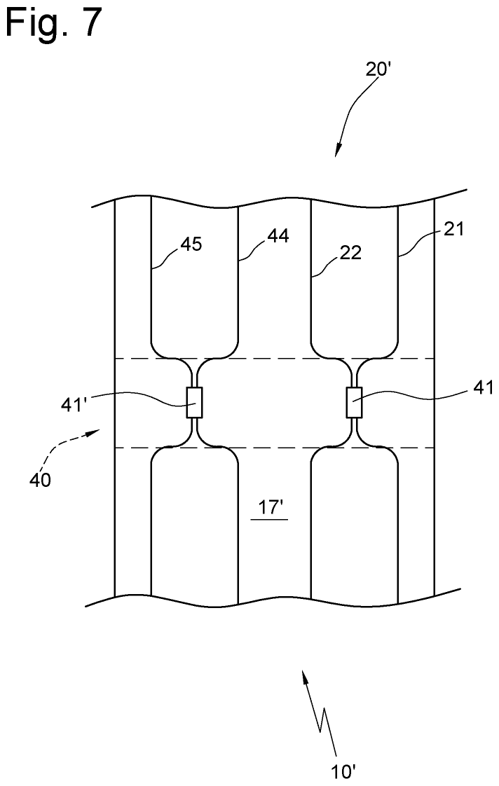

FIG. 7 shows a second exemplary embodiment of a radiant ceiling panel according to the invention, shown broken off, with a slightly modified tube configuration in plan view, which has two coupling points for the tubes in an assembly region.

Exemplary embodiments of the invention are described by way of example in the following figure description, also with reference to the drawings. For the sake of clarity—also insofar as different exemplary embodiments are concerned—identical or comparable parts or elements or regions are designated here with the same reference characters, sometimes with the addition of small letters, numbers and/or apostrophes. The same applies to the claims following the figure description.

Features described only in relation to one exemplary embodiment can also be provided in any other exemplary embodiment of the invention within the scope of the invention. Such modified exemplary embodiments—even if not shown in the drawings—are included by the invention.

All disclosed features are essential to the invention in themselves. The disclosure of the application hereby also includes the content of the disclosure of any associated priority documents (copy of the prior application) as well as of any cited printed documentation and the described prior art devices in their entirety, also for the purpose of including individual or several features of these documents in one or several claims of the present application.

FIG. 1 first shows, in a very schematic, oblique, cutaway view, two radiant ceiling panels 10 (or 10′) according to the invention, which are suspended next to each other and are arranged on the ceiling side in a room 11 configured as a hall.

Both radiant ceiling panels have a length L and a width B, wherein the length L of the radiant ceiling panels exceeds their respective width B by a multiple. In other words, the radiant ceiling panels are configured elongate.

The radiant ceiling panels 10 and 10′ are provided for air conditioning of the room 11, wherein the room 11 is formed by way of example by a floor 12, at least one wall 14, and a merely indicated ceiling 13.

The room 11 may typically contain objects 15 of any type (for example machinery, planter boxes, storage racks, office desks, or the like), particularly in the region of the floor 12.

These are merely indicated in FIG. 1.

The radiant ceiling panels 10 or 10′ serve to heat the room 11 by way of example (but can serve to cool it in alternative configurations).

The radiant ceiling panels 10 according to FIG. 1 are mainly defined by in each case one cassette 16.

Such a cassette 16 consists here of a radiating surface 17 and lateral delimitations or edges 18.

The cassettes 16 can each support a tube system, not yet shown in FIG. 1, which can conduct a fluid along the radiating surface 17.

According to FIG. 1, the cassette 16 is held in a freely suspended manner from the ceiling 13 by a fastening system 24, wherein said fastening system 24 preferably comprises (in particular multiple) fastening ropes/cables 19.

It can already be seen from FIG. 1 that the radiant ceiling panels 10 according to the invention provide a particularly attractive, because homogeneous, appearance to a user in the room 11. This is due in particular to the fact that the radiating surface 17, in particular its underside 25, is configured (substantially) planar.

This is not the case in the prior art: As FIG. 2 shows by way of example, the radiating surfaces 17′ of the prior art device typically have corrugations in which tube portions 21′,22′ are placed. Due to these corrugations, a user located under such a device does not see a corresponding appearance of the radiant ceiling panel, since it is usually not homogeneous.

This is achieved in a different manner by the radiant ceiling panel according to the invention, as shown in FIG. 3, which figure shows a cross-section, approximately orthogonal to the longitudinal extent L, through the radiant ceiling panel 10 according to the invention as shown in FIG. 1 (i.e. substantially a cross-section along the width extension B).

It can be taken from FIG. 3, that not only is the underside 25 of the radiating surface 17 planar, but in particular also the upper side 26, consequently the entire radiating surface 17.

The two portions 21 and 22 of the tube system 20 visible in FIG. 3 therefore are not placed in a corrugation, but rest (directly and/or in planar fashion) on the upper side 26 of the radiating surface 17.

In particular, as shown in FIG. 3, the two portions 21 and 22 are D-shaped in cross-section, which enables optimized heat transfer to the radiating surface 17.

The tube system 20 or the tube portions 21 and 22 are secured to the radiating surface 17 with the aid of heat conducting elements 23. The heat conducting elements 23 are formed by way of example as strip-like heat conducting plates.

In this case, the heat conducting plates 23 overlap the upper side of the tube system 20 or the portions 21, 22 and are fastened, for example adhesively bonded, with their wings to the upper side 26 of the radiating surface 17 (wherein a corresponding adhesive layer is not visible in FIG. 3 for reasons of clarity).

Lastly, it should be noted that FIG. 3 shows only two tube portions 21 and 22, but this is merely for the sake of clarity. In fact, the radiant ceiling panels according to FIG. 1 have three portions of the tube system next to each other in cross-section, as will become clear in the following figures.

FIG. 1 and FIG. 3 do not yet suggest that the entire radiant ceiling panel 10 is formed in multiple pieces in the longitudinal direction L or is fitted together from multiple pieces.

FIG. 4 shows in a very schematic oblique view of the upper side 26 such a piece 27 of the radiant ceiling panel 10 according to the invention. This view first of all allows the structure of a basic formation as a cassette 16 to be understood once again, with a radiating surface 17 as well as a lateral edge or delimitation 18. Placed in the cassette 16, on the upper side 26 of the radiating surface 17, is located the tube system 20, which is fixed there in particular in straight regions with the aid of a heat conducting plate 23 in each case.

In FIG. 4, it can further be seen that, contrary to the exemplary embodiment in FIG. 3, according to FIG. 4 the tube system 20 actually comprises three (instead of two) tube portions 21, 22 and 28 connected in parallel.

In the two end regions 29 and 30 of the piece 27, these three portions 21, 22 and 28 are guided together and in each case converge in a collector piece 31, 31′.

For this purpose, the convergence can take place close to or in the corresponding end region 29, 30 or also at some distance from the actual edge.

FIG. 4 also shows that the three portions 21, 22 and 28 are not only connected in parallel, but are actually also arranged in parallel (at least in the region of their straight extents, in particular over at least 80% of their longitudinal extent).

Finally, cross struts 32 of the cassette 16 can also be seen in FIG. 4, which in particular can increase the stability of the cassette 16, but which if necessary can also serve to attach the fastening system 24 shown in FIG. 1. For example, the ropes/cables 19 shown there can be fastened in the region of the cross struts 32 or also at fastening points, not shown, in the region of the lateral delimitation 18 or the like. However, corresponding assembly means are not shown separately in the figures for reasons of clarity.

FIG. 5 then shows, in a plan view, approximately as in FIG. 4, merely in a size-reduced illustration (with omission of further elements), how the piece 27 shown in FIG. 4 was joined together with two further pieces 33, 34, in particular end pieces, to form a radiant ceiling panel 10.

FIG. 5 omits, initially for reasons of clarity, both the cross struts 32 and the delimitations 18 of the cassette 16, so that substantially only the (fitted together) radiating surface 17 is shown of the cassette 16.

Also in FIG. 5 the heat conducting elements 23 still shown in FIG. 4 are omitted for the sake of clarity. Alternatively, FIG. 5 could also be interpreted in such a way that the tube system 20 or its individual portions, without heat conducting element, is directly fastened to the radiating surface 17, for example by a welding process or the like.

It can be seen particularly clearly from FIG. 5 that not only the piece 27 but also the pieces 33 and 34 comprise identical portions 21, 22, 28 of the tube system, so that the teaching in accordance with the invention, according to which at least two portions (in this case even three portions 21, 22, 28) are guided together and back apart again in an assembly region of the radiating surface 17, is particularly clear in this figure.

An example of such an assembly region is circled by way of example in FIG. 5 and denoted with the reference character 40 (which will be discussed in greater detail later in FIG. 6).

Consequently, the portions 21, 22, 28 are fluidically connected in parallel, as already explained, but the individual pieces 33, 27 and 34 of the radiant ceiling panel 10 are fluidically connected in series.

Therefore, the radiant ceiling panel 10 in each case has a connection 37 with an inlet tube 38 and an outlet tube 39, respectively, both in its start region 35 and in its end region 36.

Of course, the radiant ceiling panel 10 can be connected to a fluid distribution system and, if necessary, can be connected in parallel to other radiant ceiling panels or similar.

The assembly region 40, which is shown circled in FIG. 5, can be seen in FIG. 6 in an enlarged view, in which the elements of the cassette 16, which were still omitted in FIG. 5 for the sake of clarity, are partially shown again (this applies, for example, to the cross struts 32, the delimitation 18, but also to the heat conducting elements 23).

FIG. 6 shows in particular that the piece 27 of the radiant ceiling panel 10 is fluidically connected to the piece 34 of the radiant ceiling panel 10 via a connecting port 41. The connecting port 41 connects in particular the collecting piece 31′ of the piece 27, already indicated in FIG. 4, to a collecting piece 31″ of the piece 34 of the radiant ceiling panel 10.

As indicated in FIG. 6, the connecting port 41 is located slightly above the plane of the radiating surface 17 or slightly above the upper side 26 thereof. For this purpose, the collecting pieces 31′ or 31″ can, for example, be bent slightly upwards (in particular in their foot region, i.e. the region where the individual tube portions diverge again). In this way, in particular, the provision of a screen panel 43 in the region of the plane of the radiating surface 17, which will be explained shortly, is made possible.

For installation purposes, the connecting piece 41 can, for example, be placed on one of the collecting pieces 31′ or 31″ and then the two radiant ceiling panel pieces 27, 34 can be moved towards each other and the corresponding other collecting piece 31′ or 31″ can then also be inserted into the port 41.

With such an installation, the end region 29 of the radiant ceiling panel piece 27 and the end region 42 of the radiant ceiling panel piece 34 are actually located spaced apart from one another. This is also discernible in FIG. 6 by a distance A.

A further special feature of the assembling of the radiant ceiling panel 10 according to the invention is that a screen panel 43 can be provided in the assembly region 40. The screen panel 43 is thus a piece of the cassette 16, which is configured to be shorter in the longitudinal direction I, in particular, than the pieces 27 and 34. For example, the screen panel 43 can simply be clipped to the pieces 27, 34 or to their cassette portions, pushed in or the like.

For a user located in the room 11, however, there is still a homogeneous appearance of the radiant ceiling panel 10 according to the invention. In particular, the screen panel 43 also provides part of the radiating surface 17.

Typically, the screen panel 43 consists of the same material as the cassette pieces or radiating surface pieces, specifically preferably of aluminum.

The tube system 20 according to all exemplary embodiments may consist of copper or of stainless steel.

Lastly, reference is made to a last exemplary embodiment according to FIG. 7, which is a broken-off plan view of another exemplary embodiment, which again omits partial regions (such as the heat conducting elements or the like) due to the very schematic representation.

In this exemplary embodiment, a radiating surface 17′ is not associated with three portions of the tube system, but with four of them, specifically portions 21, 22, and 44 and 45.

In this exemplary embodiment, in each case two of the portions, specifically portions 21 and 22 on the one hand and portions 44 and 45 on the other hand, form a pair of portions. In each of these pairs, the two portions are guided together and back apart again in an assembly region 40. This results in two coupling points. In particular, therefore, in this exemplary embodiment, two connecting pieces 41, 41′ are provided.

As in the above exemplary embodiments, this embodiment reduces the number of coupling points of the tube system 20′, even if not all portions converge in exactly one connection, but two (separate) connections are provided. Nevertheless, this reduces the number of connections or coupling points.

This exemplary embodiment according to FIG. 7 is intended to illustrate that it is not the actual number of portions that is important, but that a wide variety of constructions fall under the inventive concept of reducing the number of coupling points.

1-11. (canceled)

12. A radiant ceiling panel for air conditioning of a room, comprising: a radiating surface; a tube system fixed on the radiating surface for conducting a fluid along the radiating surface, wherein the radiating surface has a length that exceeds a width of the radiating surface by a multiple, wherein the tube system comprises at least two portions fluidically connected in parallel; and a fastening system for freely suspended fastening of the radiant ceiling panel to a ceiling, or means for interacting with said fastening system, wherein the at least two portions are guided together and back apart again in an assembly region of the radiating surface.

13. The radiant ceiling panel according to claim 12, wherein the tube system is fixed directly to the radiating surface.

14. The radiant ceiling panel according to claim 12, wherein the at least two portions are arranged in parallel.

15. The radiant ceiling panel according to claim 12, wherein the fastening system is a rope-like fastening system.

16. The radiant ceiling panel according to claim 12, wherein the at least two portions are guided together and back apart again on or above the radiating surface.

17. The radiant ceiling panel according to claim 12, wherein the radiating surface has a planar support region for the tube system and/or has a planar underside.

18. The radiant ceiling panel according to claim 17, wherein the support region is corrugation-free.

19. The radiant ceiling panel according to claim 12, wherein the radiating surface is provided by a cassette.

20. The radiant ceiling panel according to claim 12, wherein the radiating surface is made up of a plurality of pieces.

21. The radiant ceiling panel according to claim 20, wherein the radiating surface is made up of a plurality of pieces in a longitudinal direction of the radiant ceiling panel.

22. The radiant ceiling panel according to claim 21, wherein the radiating surface in the assembly region has a shorter piece arranged between two longer pieces.

23. The radiant ceiling panel according to claim 22, wherein the shorter piece is arranged in the longitudinal direction of the radiant ceiling panel.

24. The radiant ceiling panel according to claim 23, wherein the shorter piece arranged between the two longer pieces to form a screen panel.

25. The radiant ceiling panel according to claim 12, wherein the tube system consists of copper or stainless steel and/or the radiating surface consists of aluminum.

26. The radiant ceiling panel according to claim 12, further comprising at least two further portions that are arranged in parallel, are fluidically connected in parallel with one another, and are guided together and back apart again in the assembly region, wherein the two further portions are fluidically connected in parallel as a whole to the at least two portions.

27. The radiant ceiling panel according to claim 12, wherein the tube system is fixed to the radiating surface by heat conducting elements.

28. The radiant ceiling panel according to claim 27, wherein the heat conducting elements are heat conducting plates.

29. A method for producing a radiant ceiling panel for air conditioning a room, according to claim 12, comprising the steps of: securing at least two portions of a tube system for conducting a fluid, said portions being fluidically connected in parallel on a first piece of a radiating surface, said portions being arranged in parallel and converging in a first connection; securing at least two portions of high a tube system for conducting a fluid, said portions being fluidically connected in parallel on a second piece of the radiating surface, said portions arranged in parallel and converging in a second connection; and subsequently guiding together the first and second connections.

30. The method according to claim 29, further comprising covering a region in which the two connections have been guided together with a third, shorter piece of the radiating surface.
